(19) United States
(12) Patent Application Publication
(10) Pub. No.: US 2011/0022411 A1
(43) Pub. Date: Jan. 27, 2011

(54) NFC Communications for Implanted Medical Data Acquisition Devices

(75) Inventors: Johan Hjelm, Tokyo (JP); Theo Gerrit Kanter, Ronninge (SE); Mattias Lidstrom, Stockholm (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/922,915

(22) PCT Filed: Mar. 19, 2008
(86) PCT No.: PCT/SE2008/050310

§ 371 Date: Sep. 16, 2010

(51) Int. Cl. G06Q 50/00; H04B 5/00; H04L 9/00; H04W 12/04

(52) U.S. Cl. 705/2; 455/41.2; 380/277; 455/41.1

(57) ABSTRACT

Implantable and/or wearable medical data acquisition devices (30) associated with an individual, each having NFC communication capability, collect medical data. Each device has a unique identifier. The medical data are read from the devices via a secure link by an NFC reader or transceiver (26) in a wireless communication system mobile station (10) having a unique identifier. The medical data are selectively transmitted via a secure link from the mobile station to a Presence and Group Management (PGM) server (32, 34) configured to manage data services for medical groups. Secure access to the medical data by medical professionals is restricted according to a policy system (36). Encryption keys are managed on a group basis by a group key management server (32), assigning the medical data acquisition devices (30) and mobile station (10) to groups based on their unique identifiers. The PGM server (32, 34) may send alerts and/or information to the user via the mobile station (10).

### FIELD OF THE INVENTION

The present invention relates generally to wireless communications and in particular to the collection of medical data from implanted or wearable medical data acquisition devices by a wireless communication system mobile station having Near Field Communication capabilities.

### BACKGROUND

Radio Frequency Identification (RFID) devices are well known in the art and widely deployed, e.g., as identification tags. In its simplest form, a passive RFID device includes an RF antenna and a simple electronic circuit. The circuit is powered by a small electrical current induced in the antenna in the presence of an RF carrier wave transmitted by an RFID reader. The RFID device transmits data, such as its unique identifier, by backscatter modulating the RF carrier wave. The RFID reader detects the backscatter modulation, and recovers the identifier transmitted by the RFID device. Such RFID “tags” are widely used for inventory control and supply chain management, and are expected to replace optical codes such as “bar codes” on consumer products packaging, document courier envelopes, and the like. Active RFID devices include a power source, such as a battery, and often include more sophisticated circuits (e.g., processor and memory) and a full transceiver capable of two-way communication with an RFID reader.

More generally, Near Field Communication (NFC) refers to short-range, high frequency wireless communication technology. RFID technology is a subset of NFC. NFC is an extension of the ISO 14443 proximity-card standard that combines the interface of a “smartcard” and a reader into a single device. NFC devices communicate via magnetic field induction, where two loop antennas are located within each other's near field, effectively forming an air-core transformer. It operates within the globally available and unlicensed radio frequency Industrial, Scientific, and Medical (ISM) band of 13.56 MHz, with a bandwidth of almost 2 MHz. NFC technologies are deployed in wireless communication mobile stations (e.g., cell phones, PDAs, laptops, and the like), primarily for public transportation ticketing and debit/credit payment transaction applications.

It is known in the art to provision data acquisition devices with NFC communication capabilities for embedded applications. For example, a pressure sensor and transducer coupled to an RFID communication interface may be embedded in a vehicle tire, to monitor and report inflation pressure to an RFID reader positioned near the tire. RFID tags have long been implanted in animals for identification purposes, and on a more experimental basis, in humans for identification-based applications such as access control.

One promising field of medical research is the use of implanted and/or wearable data acquisition devices having wireless communications capabilities, such as NFC. For example, an implanted device could monitor the concentration of various chemicals in the blood, such as blood sugar, anticoagulants, and the like. A wearable device could monitor body temperature or galvanic skin response. The NFC communication capability would allow for wireless transfer of medical data from the implanted or wearable device to an NFC reader. A related field of research is the use of NFC communications (or other wireless communication technology, such as Bluetooth®) to control the actuation of implanted devices, such as pacemakers, drug delivery devices, and the like. Obviously, data acquisition capability may be coupled with actuable devices having two-way NFC communications capabilities.

Data retrieval from such implanted or wearable devices is performed on an ad-hoc basis; it is limited by the requirement of a dedicated NFC reader, and the required proximity between the NFC transmitter and the reader. For example, it is anticipated that medical data would primarily be read from implanted devices when the individual is in a medical practitioner's office. The ability to retrieve data from implanted devices at any time and place would be advantageous. It would allow the collection of a time series of measured values, yielding a more complete profile of the individual's medical condition or health status than the discrete values collected during a visit to a medical practitioner's office.

However, pervasive reading of medical data from implanted devices is deficient, as the data alone is unlikely to be meaningful to an individual, absent interpretation and advice from a medical professional. Furthermore, pervasive reading of medical data from implanted devices creates a significant security risk, as medical data is highly sensitive and implicates significant privacy concerns. Finally, medical data is most efficiently utilized in a system providing group support and tiered access, allowing various interested parties (e.g., a physician, specialist, or pharmacist) access to only the level of medical data necessary to optimally provide their particular services to the individual, while safeguarding the individual's privacy.

### SUMMARY

According to one or more embodiments described and claimed herein, implantable and/or wearable medical data acquisition devices associated with an individual, each having NFC communication capability, collect medical data. Each device has a unique identifier. The medical data are read from the devices via a secure link by an NFC reader or transceiver in a wireless communication system mobile station having a unique identifier. The medical data are selectively transmitted via a secure link from the mobile station to a Presence and Group Management (PGM) server configured to manage data services for medical groups. Secure access to the medical data by medical professionals is restricted according to a policy system. Encryption keys are managed on a group basis by a group key management server, assigning the medical data acquisition devices and mobile station to groups based on their unique identifiers. The PGM server may send alerts and/or information to the user via the mobile station.

### BRIEF DESCRIPTION OF THE DRAWINGS

FIG. 1 is a functional block diagram of an NFC reader-equipped mobile station.

FIG. 2 is a functional block diagram of a CDMA Golden code receiver adapted to perform sphere decoding.

FIG. 3 is a flow diagram of a method of collecting and processing medical data associated with an individual.

### DETAILED DESCRIPTION

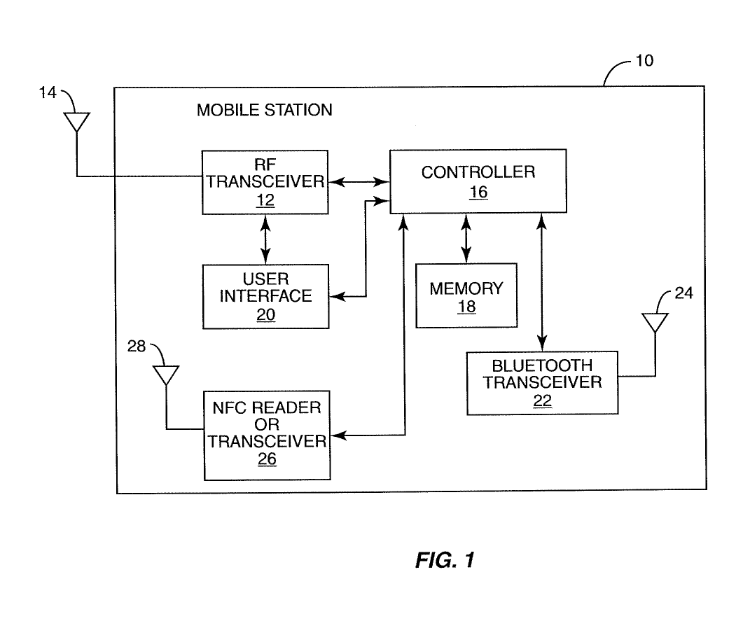

A wireless communication system mobile station 10 according to one embodiment is depicted in FIG. 1. The mobile station 10 includes an RF transceiver 12 that conforms to one or more industry-standard wireless protocols, such as WCDMA, UTRAN, GSM, or the like. The RF transceiver 12 is connected to an external antenna 14 to effect radio communications with base stations or network access points of a wireless communication system. A controller 16, connected to memory 18, controls the operation of the mobile station 10. The controller 16 may comprise a microprocessor or digital signal processor (DSP) executing software, custom hardware circuits, or any combination of hardware and software, as known in the art. A user interface 20 includes a display, keypad, speaker, microphone, and other elements to enable communication with an individual. The mobile station 10 may optionally include a Bluetooth® transceiver 22 and Bluetooth® antenna 24 (which may be disposed internal to, or incorporated into the housing of, the mobile station 10).

In one embodiment, the mobile station 10 includes an NFC reader 26, and associated NFC antenna 28, which may similarly be disposed internal to the mobile station 10 or incorporated into its housing. The NFC reader 26 is operative to energize passive NFC transmitters, and receive data from both active and passive NFC transmitters, such as by backscatter modulation. In another embodiment, the NFC reader 26 is an NFC transceiver operative to transmit data to NFC devices as well as receive data from them. As discussed more fully herein, in at least some embodiments the NFC reader or transceiver 26 communicates with NFC devices over a secure, or encrypted, link.

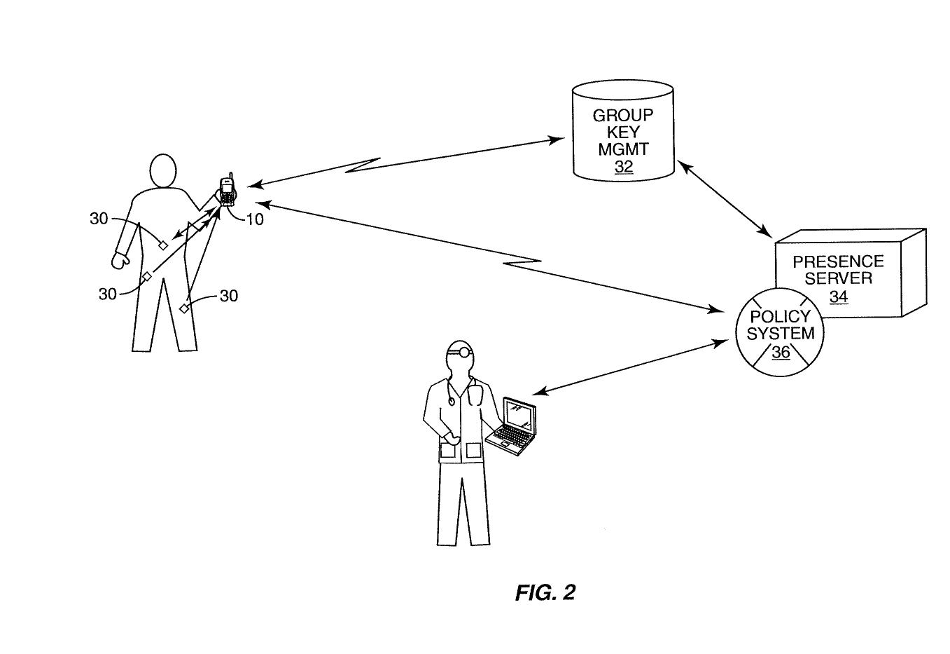

As depicted in FIG. 2 the NFC reader or transmitter 26 in the mobile station 10 is operative to receive medical data from one or more implanted or wearable data acquisition devices 30 associated with an individual. The devices 30 each comprise a sensor of some form, adapted to detect or measure medical data. The sensors detect or measure physical properties, such as chemical concentrations, temperature, pressure, flow rates, strain, or the like. Each sensor is coupled to a transducer and an NFC communication capability.

Each implanted or wearable data acquisition device 30 has a unique identifier.

Each medical data acquisition device 30 is assigned, using its unique identifier, to a group. Encryption of the communication link between medical data acquisition devices 30 and the mobile station 10 is performed according to the group to which each device 30 is assigned. The devices 30 communicate only within their assigned group—that is, the data acquisition devices 30 transmit data only to the mobile station 10 assigned to their group (via its own unique identifier). Note that an individual may have two or more groups of medical data acquisition devices 30, and the same mobile station 10 may be assigned to all groups of devices 30 associated with the individual.

Encryption may be done in the medical data acquisition devices 30, in which case they must either be updatable with a unique identifier and encryption key or alternatively their identity and key must be assigned and integrated into the devices 30 at the time of manufacture. Group encryption key management may be performed according to the 3GPPP IP Multi-Media Subsystem (IMS) protocol. The group key management server 32 associates groups of medical data acquisition devices 30 with the unique identifier of an individual's mobile station 10, and manages encryption keys for groups. The mobile station 10 includes group key management functionality required to communicate with the group key management server 32, manage the key(s) assigned to it, and implement the encryption/decryption operations to establish and manage secure links with the medical data acquisition devices 30 and other network entities. This group key management functionality may comprise, for example, one or more software modules stored in memory 18 and executed on the controller 16.

In some embodiments, data communication between the mobile station 10 and one or more implanted or medical devices 30 may be 2-way, with both links encrypted. This communication link may utilize the NFC transceiver 26, the Bluetooth® transceiver 22, or other short-range wireless communication standard. In one embodiment, a plurality of medical data acquisition devices 30, each having relatively simple, and hence low-cost, communications capabilities, communicate with the mobile station 10 via a gateway device 30 having more sophisticated communications capabilities, such as address translation. The gateway device may collect medical data for transmission to the mobile station 10, and/or may receive commands from the mobile station 10, and distribute them to the plurality of medical data acquisition devices 30.

Once medical data from an individual are received by the mobile station 10 from implanted or wearable medical data acquisition devices 30, they are selectively transmitted, over a secure link, to a presence server 34. While depicted as separate network entities in FIG. 2, the group key management server 32 and presence server 34 may be integrated. Regardless of their configuration, the servers 32, 34 together comprise a Presence and Group Management (PGM) server that has been enhanced to provide medical information and managed services tailored for medical groups.

Associated with the presence server 34 is a policy system 36 that implements access policies controlling which parties are granted access to which portions of an individual's Medical data. For example, an individual's primary care physician may have access to all medical data, including that collected by implanted or wearable medical data acquisition devices 30. A specialist, such as an oncologist, may be granted access only to that information deemed necessary to monitor and treat cancer. As another example, a pharmacist may have access to an individual's drug prescriptions, and some medical data acquired by devices 30, such as recent body temperature readings, to suggest treatments for a cold. The pharmacist would not have access to, e.g., the individual's HIV status, or past surgical records.

The specific policies implemented in the policy system 36 may be provisioned by an operator, formulated by a medical facility, and/or configured by the individual user. The mobile station 10 includes policy functionality required to communicate with the policy system 36 and enforce access controls at the mobile station 10, as dictated by active policies. For example, the mobile station 10 may require a PIN or biometric identification prior to releasing medical data through the user interface 20. This policy functionality may comprise, for example, one or more software modules stored in memory 18 and executed on the controller 16.

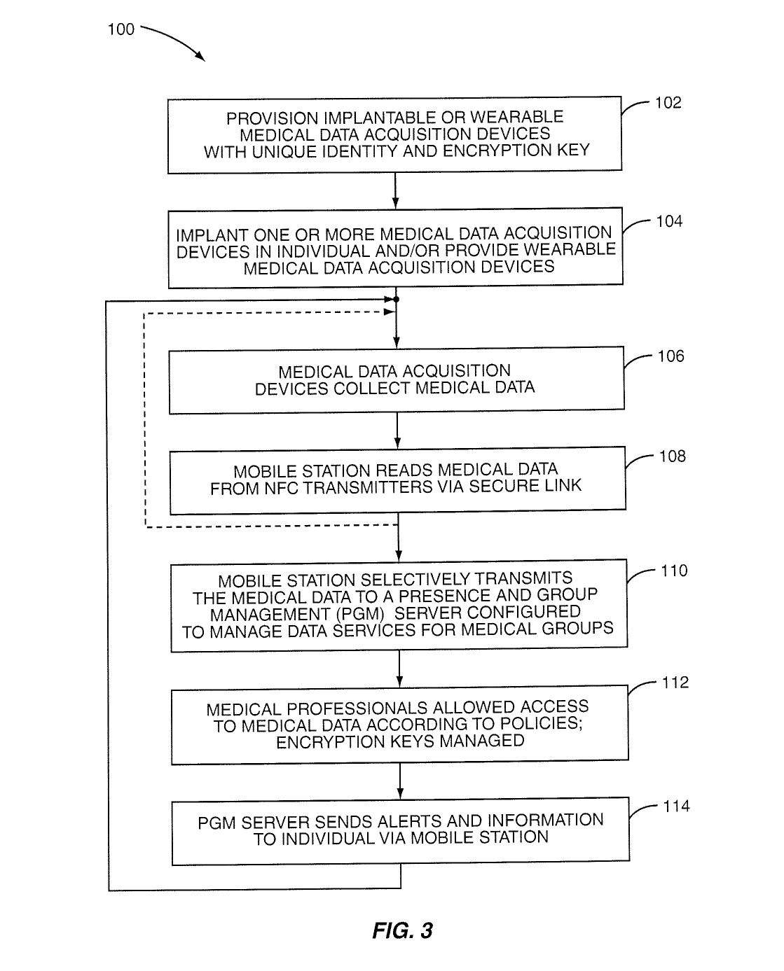

FIG. 3 depicts one embodiment of a method 100 of collecting and processing medical information about an individual. One or more implantable or wearable medical data acquisition devices 30, each including NFC communications capability, are provisioned with a unique identity and encryption key (block 102). This may be performed at the devices' 30 manufacture, or, as depicted in FIG. 3, at a medical practitioner's office, prior to implanting the devices 30 in an individual. Alternatively, the unique identifier may be provided upon the devices' 30 manufacture, and encryption keys transmitted to the devices 30 after implantation in individual, using public key encryption technology. The devices 30 are then implanted in an individual (block 104) and tested.

The medical data acquisition devices 30 collect medical data (block 106). An NFC reader or transceiver 26 in the individual's mobile station 10 reads medical data from the devices' 30 NFC transmitters via a secure (encrypted) link (block 108). In one embodiment, the reading and storage of medical data at the mobile station 10 comprises an atomic, two-phase commit operation, a well-known, robust transaction protocol that provides some immunity against corruption due to transmission failures. Not only is the data link between medical data acquisition devices 30 and the mobile station 10 encrypted to prevent interception, but the medical data acquisition devices 30 themselves will only send data to an authorized reader.

In one embodiment, indicated by the dashed line, the process of medical data collection and transmission to the mobile station 10 may be ongoing, or periodic. In this embodiment, the data are preferably time stamped to indicate either time of data collection or time of transmission to the mobile station 10. This allows a time series of data, such as body temperature, to be collected, which may provide more information than a single, discreet measurement. An individual may also input medical data, such as daily weight, blood pressure, diet, or the like, directly into the mobile station 10, via its user interface 20.

Periodically, or at scheduled times, the data are selectively transmitted to a presence server 34, which is part of a Presence and Group Management (PGM) server configured to manage data services for medical groups (block 110). In one embodiment, transmission of collected data is triggered when the data values are outside of predetermined threshold ranges, according to the policy system 36. For example, body temperature above normal (e.g., a fever) may trigger transmission of data and an alert to the PGM server for an HIV-positive individual, but may not for an HIV-negative individual.

The data transmission is preferably encrypted, using keys provided and managed by the group key management server 32. The data are ranked according to the policy system 36, and are stored in a database. Medical professionals are selectively allowed access to the medical data according to policies enforced by the policy system 36, with encryption keys for secure transmission provided and managed by the group key management server 32.

The presence server 34 may send information and/or alerts to the individual via the mobile station 10 (block 114). For example, a medical professional, after viewing data collected by the implanted and/or wearable medical data acquisition devices 30, may alter the individual's prescription medication, or its dosage, or its dosing schedule. The presence server 34 may also respond interactively to input from an individual via the mobile station 10. For example, if an individual is a shopping for an over-the-counter cold remedy, he or she may input two or more products, and the presence server 34 will indicate which is preferred, considering compatibility with the individual's prescription medications and/or other health factors. As another example, the individual's allergies or other medical intolerances may be considered in recommending over-the-counter products. This feedback may be automated and immediate, or the presence server 34 may forward user queries a medical professional, returning his or her response to the individual.

The amount and sensitivity of medical data released varies according to policies implemented by the policy system 36. In the above example, if the individual's pharmacist poses a query to the presence server 34, he or she may receive more complete information about the individual's prescription medications and/or other health factors, in order to advise the individual, than the individual would receive directly. In one embodiment, if the pharmacist desires more information than the relevant policy allows—for example, if an individual volunteers the existence of a medical condition, of which the relevant policy would not normally inform the pharmacist—the individual may override the policy and authorize the dissemination of additional medical data.

Of course, the hardware, system architecture, and functionality provided by embodiments of the present invention enable a broad array of methods or modes of use, in addition to be straightforward monitoring of medical data described above. For example, individuals may use of the system to design a self-care cures. The policy system 36 may create alerts as individuals approach safety thresholds in dosing or drug interaction, for example by reference to medical and pharmaceutical dictionaries (e.g., FASS in Sweden or FDA in USA).

The data collected by implanted or wearable medical data acquisition devices 30 may be combined with other medical and health data to monitor drug efficacy in curing illnesses, drug interactions, and the like. This may enable fine tuning of a course of medical treatment customized to a specific individual in a manner and to a degree unprecedented in the prior art. The data may additionally be extracted (removing personal identifying information) and combined with similar data relating to other individuals on some courses of treatment, further contributing to the body of known medical data.

The system also allows for greater control of the actuation of implanted medical devices. For example, an implanted drug delivery device may be actuated at specific times to release specific dosages in response to very recent medical data collected by implanted or wearable medical data acquisition devices 30. That is, embodiments of the present invention allow for ubiquitous and pervasive near-real-time control of drug therapy—something achieved in the prior art only in a controlled environment, such as a hospital room.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1-22. (canceled)

23. A method of collecting and processing medical information about an individual, wherein the individual has a wireless communication system mobile station having a unique identifier, and one or more medical data acquisition devices are associated with the individual, each medical data acquisition device having a short-range wireless communication transmitter and a unique identifier, said method comprising:
collecting medical data by the one or more medical data acquisition devices;
reading medical data from the one or more medical data acquisition devices via a secure link by a wireless communication receiver in the mobile station, wherein the secure link is established according to a group encryption key management system;
grouping the medical data acquisition devices by their unique identifiers and associating them with the mobile station by the mobile station's unique identifier; and
selectively transmitting the medical data from the mobile station to a server configured to manage data services for medical groups.

24. The method of claim 23, wherein the short-range wireless communication transmitter in each medical data acquisition device comprises a Near Field Communication (NFC) transmitter, and the wireless communication receiver comprises an NFC reader.

25. The method of claim 24, wherein the NFC transmitter comprises a passive or active Radio Frequency Identification (RFID) transmitter.

26. The method of claim 24, wherein the NFC transmitter is a transceiver, and wherein the NFC reader in the mobile station is further operative to write data to the transceiver in the NFC transmitter in each medical data acquisition device via a secure link.

27. The method of claim 23, wherein the server comprises a Presence and Group Management (PGM) server configured to manage data services for medical groups.

28. The method of claim 23, wherein the one or more medical data acquisition devices associated with the individual comprise one or more implanted medical data acquisition devices implanted within the individual's body.

29. The method of claim 23, wherein the one or more medical data acquisition devices associated with the individual comprise one or more wearable medical data acquisition devices worn by the individual.

30. The method of claim 23, further comprising actuating one or more medical devices by the mobile station.

31. The method of claim 23, wherein the group encryption key management system comprises a 3GPPP IP Multi-Media Subsystem (IMS).

32. The method of claim 23, wherein selectively transmitting the medical data from the mobile station comprises transmitting the medical data according to a policy management system.

33. The method of claim 32, wherein dissemination of the medical data is restricted according to one or more policies established for the individual within the policy management system.

34. The method of claim 23, wherein the medical data comprise discrete values.

35. The method of claim 23, wherein the medical data comprise a time series of values.

36. The method of claim 23, wherein the collecting medical data by one or more medical data acquisition devices associated with the individual comprises collecting medical data by a plurality of medical data acquisition devices associated with the individual, each medical data acquisition device communicating the medical data to a gateway medical data acquisition device; and wherein the reading medical data from the one or more short-range wireless communication transmitters via a secure link by the wireless communication receiver comprises reading the medical data from the gateway medical data acquisition device.

37. A wireless communication system mobile station having a transceiver, the mobile station further comprising:
a short-range wireless communications receiver, comprising a Near Field Communication (NFC) reader, and which is operative to engage in secure bidirectional communications with one or more medical NFC transmitters, to at least read medical data via one or more secure links from one or more medical data acquisition devices associated with an individual; and
a group key management module operative to establish and manage the one or more secure links, the one or more secure links established according to a group encryption key management system, said group encryption key management system being configured to group medical data acquisition devices by their unique identifiers and associate them with the mobile station by the mobile station's unique identifier;
wherein the transceiver is operative to communicate the medical data to a server configured to manage data services for medical groups.

38. The mobile station of claim 37, wherein the server comprises a Presence and Group Management (PGM) server configured to manage data services for medical groups.

39. The mobile station of claim 37, wherein the secure bidirectional communications include atomic, two-phase commit operations.

40. The mobile station of claim 37, wherein the group key management module is further operative to manage the secure bidirectional communications with the one or more medical NFC transmitters according to a 3GPPP IP Multi-Media Subsystem (IMS).

41. The mobile station of claim 37, wherein the one or more medical NFC transmitters associated with the individual form a group for key management purposes.

42. The mobile station of claim 37, further comprising a policy module operative to selectively communicate the medical data in accordance with one or more predetermined policies.

43. A Presence and Group Management (PGM) server comprising a presence server associated with a policy system and a group key management server, the PGM server adapted to manage data services for medical groups, wherein:
the presence server is operative to receive, via a wireless communication system mobile station, medical data obtained from implanted or wearable medical data acquisition devices associated with an individual, store the medical data in a database, and implement predetermined policies restricting access to the medical data;
the group key management server is operative to manage encryption keys on a group basis; and
the medical data associated with the individual are retrievable from the database in accordance with the predetermined policies, over secure links with the encryption keys managed by the group key management server, wherein the secure links are established according to a group encryption key management system, which groups the medical data acquisition devices by their unique identifiers and associating them with the mobile station by the mobile station's unique identifier.

44. The PGM server of claim 43, wherein the group key management server implements a 3GPPP IP Multi-Media Subsystem (IMS) protocol.
